(19) United States
(12) Patent Application Publication
(10) Pub. No.: US 2010/0061420 A1
(43) Pub. Date: Mar. 11, 2010

(54) System and Method for Measuring Insulation R-Value

(75) Inventor: Mary Elizabeth Parks, Hamilton, NY (US)

Correspondence Address: BOND, SCHOENECK & KING, PLLC, ONE LINCOLN CENTER, SYRACUSE, NY, 13202-1355, US

(73) Assignee: COLGATE UNIVERSITY, Hamilton, NY (US)

(21) Appl. No.: 12/555,371

(22) Filed: Sep. 8, 2009

Related U.S. Application Data
(60) Provisional application No. 61/094,636, filed on Sep. 5, 2008.

(51) Int. Cl. G01N 25/18

(52) U.S. Cl. 374/44; 702/136

(57) ABSTRACT

A system and method for measuring the R-value of thermal insulation. The temperature difference between the insulation surface and the surrounding air layer is measured, as is the temperature difference between the air at the outer and inner surface of the insulation. Using these measurements and the resistance value of the surrounding air layer, the R-value of the insulation is calculated.

### CROSS REFERENCE TO RELATED APPLICATION

The present application claims priority to and incorporates by reference the entirety of U.S. Provisional Patent Application Ser. No. 61/094,636, filed Sep. 5, 2008.

### BACKGROUND OF THE INVENTION

1. Field of the Invention

The present invention is related to a system and method for measuring the thermal resistance of a thermal insulator, and, more particularly, to a system and method for determining the R-value of insulation.

2. Description of the Related Art

Thermal energy travels from an area or surface of higher temperature to an area or surface of lower temperature. This thermal energy can be transferred by conduction, convection, radiation, or a combination of the three. Although thermal energy transfer can never be completely stopped until equilibrium is reached, the rate of transfer can be reduced by materials known as thermal insulators.

In a building, thermal insulation reduces the rate of thermal energy transfer between the exterior and interior environments reducing the energy required to keep the building warm during cold months and cool during warm months. To reduce heat transfer, buildings are typically constructed with insulation between the interior and exterior walls, in ceilings, in floors, around windows, and in the roof. Effective thermal insulation can decrease the amount of resources needed by heating and cooling systems to maintain a comfortable temperature inside the building, thus reducing energy expenditures.

The effectiveness of thermal insulation is measured by its thermal resistance. In the insulation industry, the standard measure of an insulator's ability to resist thermal energy transfer is referred to as the insulation's R-value. The higher the R-value, the more effective the insulation. Knowing a material's R-value allows contractors, building inspectors, and homeowners to compare products and calculate the amount of insulation needed for a particular construction project. Additionally, regulatory agencies use R-values to establish recommended or mandatory guidelines for new buildings.

While the R-value of insulation installed into a newly-constructed building is usually known, the current R-value of insulation installed in existing homes is almost always unknown because construction specifications are not normally passed along when a house is sold. Many older homes were constructed and insulated before effective insulation was either invented or mandated by local building codes. Additionally, some homes were constructed and insulated under the assumption that energy costs associated with heating and cooling a building would never exceed the costs of expensive insulation.

The R-value of most insulation decreases over time, meaning that the effectiveness of the insulation has decreased and the rate of thermal energy transfer has increased. Insulation can settle within walls, floors, or ceilings, resulting in uneven distribution of the insulation. Some foam or blown insulations manufactured with agents other than air experience a slow loss of the agent and thus a loss of R-value. Other environmental factors such as insects, freeze-thaw cycles, and moisture can also degrade the R-value of insulation. Additionally, the R-value of most insulation is based on Long Term Thermal Resistance (LTTR), a method of calculating the 15-year time-weighted average R-value. As a result, the current R-value of insulation that was installed more than 15 years ago is usually unknown.

Although there are devices such as infrared thermometers that measure the temperature of different regions of a wall to identify areas of high thermal leakage, there is currently no device that measures the temperature difference between a wall and the surrounding air in order to quantitatively determine the R-value of insulation inside the wall. Such a device would give homeowners and building owners affordable means to detect and remediate inefficient or inadequate insulation.

It is therefore a principal object and advantage of the present invention to provide a system and method for determining the thermal resistance of insulation.

It is another object and advantage of the present invention to provide a quick and reliable method for determining the R-value of insulation.

It is a further object and advantage of the present invention to provide a method for homeowners, energy auditors, or building inspectors to determine the current R-value of insulation in both new and old buildings.

It is another object and advantage of the present invention to provide a method for identifying installed insulation with a low R-value, thus allowing remediation measures such as replacing or adding insulation, thereby increasing energy efficiency and savings.

### SUMMARY OF THE INVENTION

A method for determining the thermal resistance of insulation, the method comprising one or more of the steps of: (1) measuring the temperature difference between a surface of the insulation and the surrounding air; (2) measuring the total temperature difference between the air surrounding the exterior and interior surfaces of the insulation, or alternatively the actual surface temperatures; and (3) calculating the R-value of the insulation with the two measurements.

A system for determining the thermal resistance of insulation, the system comprising: (1) a first means to measure the temperature difference between a surface of the insulation and the surrounding air; (2) a second means to measure the total temperature difference between the air surrounding the exterior and interior surfaces of the insulation, or alternatively the actual surface temperatures; and (3) a third means for calculating the R-value of the insulation with the two measurements.

### BRIEF DESCRIPTION OF THE DRAWINGS

The present invention will be more fully understood and appreciated by reading the following Detailed Description in conjunction with the accompanying drawings, in which:

FIG. 1 is a schematic representation of thermal flow across two thermal resistors in series.

FIG. 2 is a flowchart showing an example overview of a method for determining the R-value of insulation according to the present invention.

FIG. 3 is an elevation view of a thermocouple that may be practiced in an embodiment of the present invention.

FIG. 4 is an elevation view of an components that may be practiced in an alternate embodiment of the present invention.

### DETAILED DESCRIPTION OF THE INVENTION

The thermal resistance of an unknown thermal insulator such as a wall can be determined by measuring the temperature drop across a known thermal resistance in series with it. The process is analogous to measuring the resistance of an element in an electrical circuit, as similar equations govern both processes. This invention makes use of the fact that a solid surface, such as a wall, traps a thin layer of air next to it. This thin (less than 1 inch) layer acts as an additional thermal resistance in series with the wall.

The equation for measuring heat flow per unit area is:

$$\frac{Q}{t \cdot A} = \frac{Δ T}{R}$$

where Q is heat, t is time, A is total surface area, ΔT is the temperature difference, and R is the value of the thermal resistance. The heat flow equations states that the rate of heat flow per unit area equals the temperature difference divided by thermal insulation.

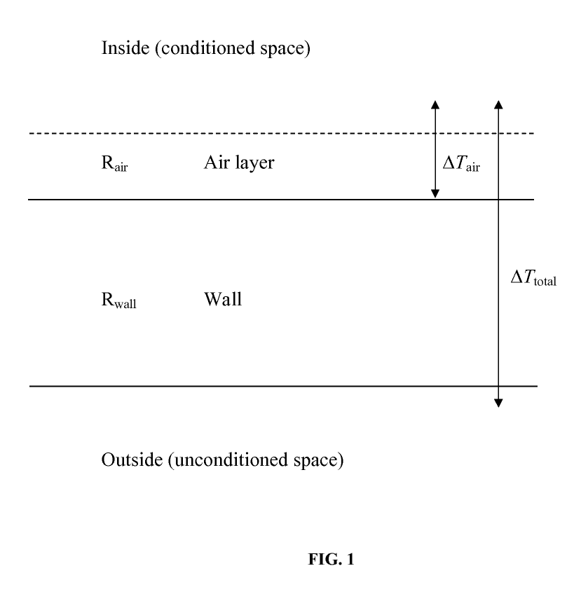

FIG. 1 is a graphical representation of the geometry of two thermal resistors, Rₐᵢᵣ and R_{wall}, in series. The thermal difference across Rₐᵢᵣ is represented by ΔTₐᵢᵣ, and the total thermal difference across both Rₐᵢᵣ and R_{wall} is represented by ΔTₜₒₜₐₗ. The total thermal resistance of a wall is due to a combination of the wall materials and the thin layer of air that is trapped next to its surface. In the steady state, the rate of heat flow through each layer is equal, which makes possible the calculation of the thermal resistance of the unknown thermal insulator R_{wall} using the following equation:

$${R}_{wall} = {R}_{air} \frac{Δ {T}_{wall}}{Δ {T}_{air}} = \frac{{R}_{air} ( Δ {T}_{total} - Δ {T}_{air} )}{Δ {T}_{air}}$$

This equation makes clear the most important aspects of the measurement. By measuring the small temperature drop that occurs across the air layer, it is possible to calculate the thermal resistance of the wall.

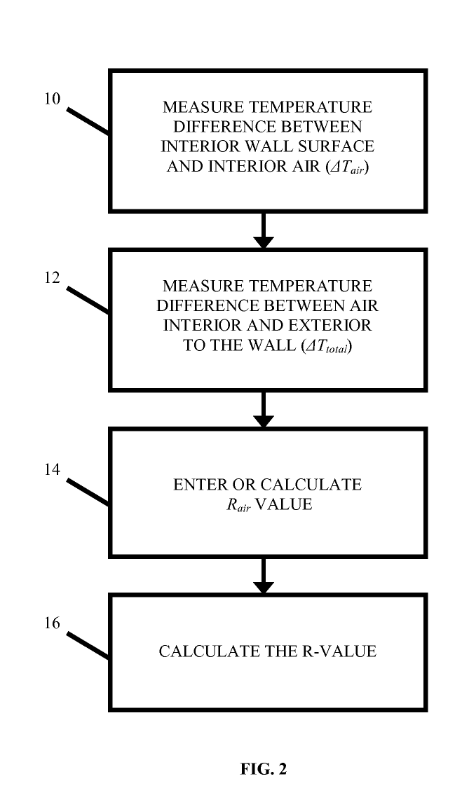

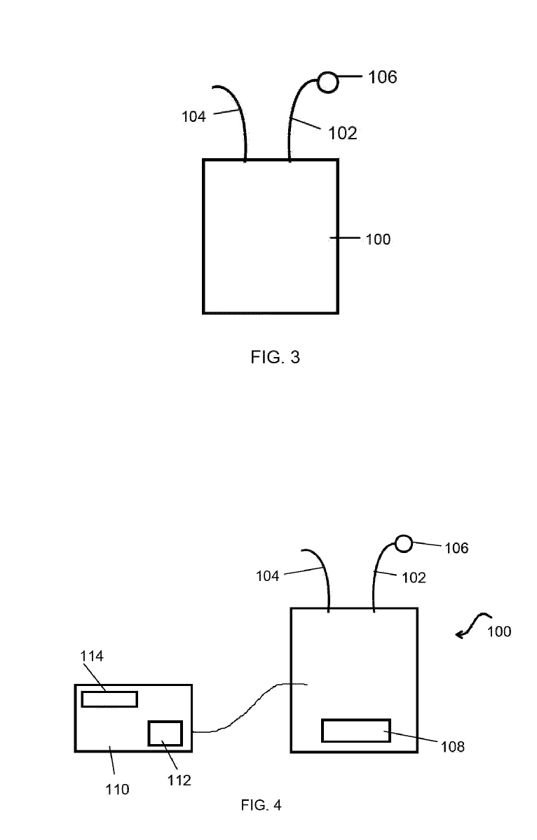

FIG. 2 is a flowchart showing an example overview of a method for determining the R-value of insulation according to the present invention. Although the flowchart is directed to the measurement of the R-value of insulation in the wall of a building, one skilled in the art would recognize that the method can be used to measure R-values of ceilings, windows, floors, and roofs, as well as non-architectural objects such as refrigerators, freezers, and hot water heaters. The method can also be used in industrial settings to measure R-values associated with manufacturing, shipping, and other commercial endeavors.

As an initial step 10, the temperature difference between an interior wall surface and the surrounding interior air layer (ΔTₐᵢᵣ) is measured. In a preferred embodiment, the temperature difference is measured by a thermocouple with one junction in close thermal contact with the surface of the wall and the other junction held away from the wall. Other methods for obtaining these temperature measurements are known in the art.

In step 12, the temperature difference between the air on the interior and exterior of the wall (ΔTₜₒₜₐₗ) is measured. This measurement can be obtained using a traditional mercury thermometer, or through any of the other known methods in the art for obtaining temperatures.

In step 14, the resistance value for the internal layer of air (Rₐᵢᵣ) is either entered as an average or constant value, or is calculated specifically for the testing in question. A frequently cited value for Rₐᵢᵣ in an indoor setting is 0.68 ft² hr ° F./Btu, and this value could be used in further calculations according to the present method. However, it is possible that the Rₐᵢᵣ value will vary depending on various factors such as location, climate, time of day, particulate suspension, and air circulation, among others.

In the final step of the method, step 16, the R-value is calculated using the ΔTₐᵢᵣ, ΔTₜₒₜₐₗ, and Rₐᵢᵣ values. In the preferred embodiment, the R-value is calculated using the following calculation:

$${R}_{wall} = {R}_{air} \frac{Δ {T}_{wall}}{Δ {T}_{air}} = \frac{{R}_{air} ( Δ {T}_{total} - Δ {T}_{air} )}{Δ {T}_{air}}$$

In one embodiment of the present invention, the method according to the present invention is implemented using a thermocouple 100 (or other temperature measuring device and sensors). A thermocouple is a temperature sensor having first and second junctions 102 and 104 at the joined ends of two wires composed of different metals and that measures the voltage created by a thermal gradient. At least one junction 102 (or 104) of the thermocouple can be embedded in thermally conductive epoxy 106 and placed against the wall, while the other junction can be held away from the surface of the wall. In this way, the thermocouple can measure the small temperature difference across the air layer outside the wall. An advantage of this embodiment is that the thermocouple voltage is directly sensitive to the desired quantity, the temperature difference. If the two temperatures are measured separately and the difference is calculated from the two measurements, the amount of error is increased.

In another embodiment, the method according to the present invention is implemented using a single hand-held device. The device would contain a thermocouple 100 with two junctions 102/104, a voltage sensor 108, and a microprocessor 110. To measure the R-value of insulation in a wall, for example, the user could enter via a entry device, such as a keypad, 112 values representing the indoor and outdoor temperatures into the device and then position the thermocouple junctions to measure the temperature difference across the inside air layer as described previously. The microprocessor could then use the input values and the direct measurement to calculate the R-value of the insulation. The display 114 of the hand-held device could show the calculated R-value, as well as yearly energy savings if the R-value were increased. The microprocessor could also request, process, or display other factors associated with measuring R-values and energy expenditures, including geographic location, climate information, energy costs, regulatory requirements, and estimated age of the house and/or insulation, among others.

The method could be used in other household applications, including measuring the R-value of insulation surrounding hot water tanks, refrigerators, or pipes. There are also industrial applications, including measuring the R-value of insulation in industrial buildings, insulation surrounding hot or cold liquid storage tanks and facilities, and insulation surrounding pipes.

In another embodiment of the present invention, the method could be used to determine one or more locations within a single wall or other insulation-containing surface that have a lower R-value due to insulation gaps or settling. A mapping feature could record multiple R-values over the area of a surface and create an R-value map that shows contours or other indicators of changes in the R-value, similar to a topographic map, although other methods of displaying temperature differences are known in the art. The map could then be used to target remedial efforts to specific locations within the wall or surface without performing extensive remodeling.

### EXAMPLES

The method according to the present invention was used to measure the R-value of insulation in a recently constructed building. The exterior walls of the building were constructed with a total insulation layer of R=19, a ⅝ inch sheet of gypsum wallboard with an R-value of 0.9 per inch, and a exterior siding layer with an unknown R-value. Thus, the total R-value of the exterior wall was estimated to be between 20 and 21.

The total temperature difference between the outside and inside of the exterior wall (ΔTₜₒₜₐₗ) was measured to be 21.5±1 degree Celsius using a mercury thermometer. The temperature difference between the interior of the wall and the inside air (ΔTₐᵢᵣ) was measured with an E-type (nickel-aluminum and nickel-chromium) thermocouple, with one of the thermocouple junctions embedded in a thermally conducted epoxy (www.epoxies.com, Product 50-1225) that was shaped into a thin disk and held against the interior surface of the wall. The measured response of the thermocouple was 0.0583 mV/° C., and the average voltage difference measured across the thermocouple configuration was 0.040 mV. Therefore, the temperature difference was calculated as ΔTₐᵢᵣ=(0.040 mV)/(0.0583 mV/° C.)=0.69° C. With the calculated value for ΔTₐᵢᵣ=0.69° C., the R-value could be calculated with a known value for Rₐᵢᵣ of 0.68 ft² hr ° F./Btu for indoor surfaces.

Thus, the R-value was calculated to be 21:

$${R}_{wall} = \frac{{R}_{air} ( Δ {T}_{total} - Δ {T}_{air} )}{Δ {T}_{air}} = \frac{0.68 ( 21.5 ° C . )}{( 0.69 ° C . )} = 21$$

The calculated R-value of 21 is very comparable to the estimated value of 20-21 based on information regarding insulation and construction of the building.

What is claimed is:

1. A method using a temperature measuring device for determining the thermal resistance of insulation having interior and exterior surfaces, comprising the steps of:
a. using the temperature measuring device to measure the temperature difference between a surface of the insulation and the air surrounding the insulation;
b. using the temperature measuring device to measure the total temperature difference between at least one of the air surrounding the exterior and interior surfaces of the insulation and the actual exterior and interior surface temperatures of the insulation; and
c. calculating the thermal resistance of the insulation.

2. A system for determining the thermal resistance of insulation having interior and exterior surfaces, comprising:
a. a temperature measuring device adapted to measure a first temperature comprising the temperature difference between a surface of the insulation and the air surrounding the insulation, and a second temperature comprising the total temperature difference between at least one of the air surrounding the insulation and the interior surface of the insulation and the interior and exterior surface temperatures of the insulation; and
b. a calculating unit adapted to receive said first and second temperatures and calculate the thermal resistance using said first and second temperatures.

3. The system according to claim 2, wherein said temperature measuring device comprises a thermocouple having first and second junctions.

4. The system according to claim 3, wherein at least one of said first and second junction s is embedded in a thermally conductive epoxy.
